(19) United States
(12) Patent Application Publication
(10) Pub. No.: US 2023/0259082 A1
(43) Pub. Date: Aug. 17, 2023

(54) Method and System for Verifying an Application of a Foamable Material Onto a Carrier

(71) Applicant: BASF SE, Ludwigshafen am Rhein (DE)

(72) Inventors: Tomasz CWIK, Wyandotte, MI (US); Thomas CHASE, Wyandotte, MI (US)

(21) Appl. No.: 18/003,738

(22) PCT Filed: Jul. 1, 2021
(86) PCT No.: PCT/EP2021/068218

§ 371 Date: Dec. 29, 2022

(30) Foreign Application Priority Data
Jul. 2, 2020 (EP) 20183787.9

(51) Int. Cl. G05B 15/02

(52) U.S. Cl. CPC G05B 15/02

(57) ABSTRACT

Disclosed herein is a method for verifying an application of a foamable material onto a carrier to manufacture an insulated member. The method includes:

capturing (S1), by at least one image capturing device, in image data a surface of the carrier onto which the foamable material is applied,

receiving (S2), by at least one data processing unit, input data including at least the captured image data and at least one application parameter associated therewith, and

processing (S3), by the at least one data processing unit, the received input data by performing at least image analysis on the image data and by taking into account the at least one application parameter, and thereby determining an application quality of the applied foamable material.

The present application relates to a method and a system for verifying an application of a foamable material onto a carrier to manufacture and/or during manufacturing an insulated member, and a method for training a computational model for verifying an application of a foamable material onto a carrier to manufacture and/or during manufacturing an insulated member.

A carrier with foamable material applied thereto may be used in different technical and/or industrial fields. By way of example, such a carrier with foamable may be used for insulation purposes, such as manufacturing an insulated member that can be used in many ways, for example, to achieve thermal insulation, sound insulation or the like. The field of application of such an insulated member is correspondingly wide and extends, for example, to applications in numerous industries, such as construction industry, automotive industry, packaging industry etc. By way of example, such insulated members may be used as an interior trim, as an exterior wall cladding, as a construction member, as packaging material, or the like, usable in a wide range of industries.

The process of applying the foamable material to the carrier can depend on several factors, so that the quality of the process or the result can vary and in some cases may not be satisfying. Exemplary defects can appear in many different ways and may include e.g. gaps, uneven thickness distribution etc. At present, a quality verification of the process or its result respectively, is carried out manually, wherein the final result is inspected, measured if necessary, etc., in order to verify the quality of the application of the foamable material and to assess it if necessary. Thus, the quality verification is rather subjective and depends on e.g. the experience, daily form, etc. of the person performing it, the equipment used for the quality verification, etc.

Therefore, there may be a need for providing more efficient and effective means for verifying an application of a foamable material onto a carrier. It is accordingly an object of the present invention to provide more efficient and effective means for verifying an application of a foamable material onto a carrier. This object is solved by the subject-matter of the independent claims.

A first aspect of the invention provides a, preferably computer-implemented, method for verifying an application of a foamable material onto a carrier to manufacture and/or during manufacturing an insulated member. The method comprises the steps of:

Capturing, by at least one image capturing device, in image data a surface of the carrier onto which the foamable material is applied.

Receiving, by at least one data processing unit, input data comprising at least the captured image data, at least one application parameter associated therewith and formulation information of the foamable material.

Processing, by the at least one data processing unit, the received input data by performing at least image analysis on the image data and by taking into account the at least one application parameter and the formulation of the foamable material, and thereby determining an application quality of the applied foamable material.

This allows at least semi-automatically verifying, i.e. checking and/or assessing, the quality of the foamable or the material foamed over time after applying it onto the carrier. This verification is based on image capturing and image analysis. Thereby, one or more parameters related to the application or the process of applying the material are considered. This can objectify the quality verification and contribute e.g. to a more stable process, a reliable (end) product, less scrap, cost savings and other technical advantages. Taking into account the formulation of the foamable material allows the application quality to be determined even more precisely. This method may be implemented, for example, in a computer program element comprising computer instructions that can be carried out by the at least one data processing unit, e.g. a processor, preferably comprising e.g. one or more circuits. Further, the method may be carried out by a single computing device or system, or by a distributed computer system comprising, for example, a computing cloud and an edge computing device. In some embodiments, the system may further comprise a remote terminal, a portable device or the like, configured to communicate with the system or one or more of the above computing devices. If the method is carried out by an edge computing device, the method or the computer program element respectively may be provided by download to be locally stored on the edge computing device. If the method is carried out by a distributed computer system, some of the above method steps, such as capturing the image data, may be performed on a first location, such as a manufacturing site where the foamable material is applied, and some of the above method steps, such as the data processing, may be performed on a second location, such as a computing cloud. In the latter case, the image data may be provided from the first location to the second location. Then, data resulting from the data processing may be provided from the second location back to the first location.

As used herein, the foamable material may comprise a foamable plastics material, such as polyurethane (PUR), polystyrene, etc. After foaming, the foamable material may also be referred to as foam. The process of foaming may comprise an exothermic process of the material.

The carrier may, for example, be a frame part, etc., where the foamable material is applied to at least one surface, in one or more cavities, etc. It may be made from another plastics material, wood, a combination of materials, etc. The resulting product or part, i.e. the carrier with the foamable material or foam applied thereto, may also be referred to as an insulating member or the like.

The image capturing device may comprise one or more of, for example, a camera, a thermal camera, an image sensor, etc., and may be permanently installed (or fixed) in a production environment where the material is applied to the carrier, or may be part of a mobile device such as a mobile phone, smart phone, etc. Note that the image capturing device may be controlled by a suitable computer application carried out by the above or another at least one data processing unit. The image data generated by the image capturing device may be provided to e.g. the at least one data processing unit via a suitable data interface, etc.

The at least one data processing unit may comprise a data processor. It should be noted that data processing may be distributed to several data processing units that may also be run remotely, such as a computing cloud that performs part of the data processing and an edge computer that performs another part of the data processing. It is also possible, for example, that a mobile terminal performs one of the parts of the data processing or an additional part.

The term image analysis may be broadly understood. It may comprise, for example, an extraction of meaningful information from images by means of digital image processing techniques, such as e.g. 2D and 3D object recognition, image segmentation, motion detection e.g. Single particle tracking, video tracking, optical flow, etc. It may utilize one or more image analysis tools, such as an edge detector, a neural network, or the like. As used herein, the result of the image analysis may be information, for example, about one or more sections of the surface of the carrier, indicating whether material is applied there, a thickness of the material, whether there are gaps, whether there are recesses, etc.

For example, the several input data may be correlated with each other, i.e. the least image analysis on the image data, the at least one application parameter and the formulation of the foamable material may be correlated with each other. This may allow, for example, considering a time-dependent foaming state of the foamed material applied, since the process of foaming takes place over a period of time. In this way, the application and/or foam quality can even be assessed before the foaming process is fully completed, and/or can be assessed more precisely as time dependency of foaming is considered. Because, the progress of the foaming process is known from the formulation and an expected value, indicator, etc., for the time-dependent foaming state for a certain time measured from applying the foamable material can be derived from it. Alternatively or additionally, the progress of the foaming process and/or the time-dependent foaming state may be modelled, etc.

The term application quality of the applied foamable material may be an indication from which it can be deduced whether a specification of the product can be complied with or which indicates that the quality is sufficient or insufficient.

According to an embodiment, the method may further comprise generating, by the data processing unit, output data at least comprising the determined application quality of the applied foamable material and/or an assessment thereof. The output data may be used, for example, to create a notification and/or message to an operator or user indicating whether or not the application quality is sufficient or meets a specification respectively. Further, the output data may be provided, e.g. transmitted, via a data interface, a computer network, a communications network, etc., to e.g. a remote terminal, a remote computer device, or the like, and/or may be used by a computer application.

In an embodiment, the output data may be used to adjust or to trigger an adjustment of, particularly if the determined application quality is considered insufficient, one or more of: the foamable material used, and the at least one application parameter. For example, the output data may be provided to a warehouse to initiate the provision of another, probably more suitable foamable material, and/or to a foam application device to adjust one or more application parameters, in order to achieve better quality.

According to an embodiment, the at least one data processing unit may utilize a computational model, which may be stored in e.g. a memory or the like, configured to process the input data and/or determine the application quality. For this purpose, the computational model may be trained by sample data at least comprising annotated image data, annotated application parameter data associated therewith and an assessment of the quality or defect of the application of applied foamable material associated therewith. In other words, the computational model, e.g. machine learning model, may be trained to learn how a desirable application of foam looks like and/or how different defects looks like. The term computational model may be broadly understood and may, for example, refer particularly to a model built from one or more machine learning algorithms based on sample data in order to make a prediction and/or decision regarding the application of the foamable material or the application quality of it respectively. For example, the machine learning algorithm may comprise decision trees, naive bayes classifications, nearest neighbors, neural networks, convolutional neural networks, generative adversarial networks, support vector machines, linear regression, logistic regression, random forest and/or gradient boosting algorithms. The computational model may be understood as an entity that processes one or more inputs into one or more outputs by means of an internal processing chain that typically has a set of free parameters. The internal processing chain may be organized in interconnected layers that are traversed consecutively when proceeding from the input to the output. The computational model may be capable of being “trained”. It may be trained using records of training or sample data. A record of training data comprises training input data and, preferably, corresponding training output data. The training output data of a record of training data is the result that is expected to be produced by the module when being given the training input data of the same record of training data as input. The deviation between this expected result and the actual result produced by the module is observed and rated by means of a “loss function”. This loss function is used as a feedback for adjusting the parameters of the internal processing chain of the module. For example, the parameters may be adjusted with the optimization goal of minimizing the values of the loss function that result when all training input data is fed into the computational model and the outcome is compared with the corresponding training output data. The result of this training is that given a relatively small number of records of training data as “ground truth”, the computational model is enabled to perform its job, e.g., the classification of images as to which objects they contain, well for a number of records of input data that higher by many orders of magnitude. For example, a set of about 100, 1000, or more training images that has been “labelled” or annotated with the ground truth of which objects are present in each image may be sufficient to train the module so that it can then recognize these objects in all possible input images, which may, e.g., be over 530 million images at a resolution of 1920×1080 pixels and a color depth of 8 bits.

It may also be configured to assess the application quality, e.g. by comparison with reference data or a specification of the product to be manufactured. The computational model may be pre-trained by using the sample data and/or may be re-trained over the time to improve the overall quality of the computational model itself.

In at least some embodiments, a test mode may be carried out for verifying the at least one application parameter before carrying out the actual part manufacturing job. For example, the test mode may comprise pre-spraying an amount of the foamable material to verify whether the application quality, e.g. the spray pattern, is according to specification. In this case, the computational model may be trained and/or pre-trained separately for the purposes of determining the application quality of the test mode and of the actual manufacturing job.

In an embodiment, the method may further comprise generating, by the at least one data processing unit, control data to be processed by a foam application device. Thereby, the control data may be configured to control the foam application device for one or more of: reworking at least one section of the surface of the carrier where the application quality has been determined to be insufficient, and adjusting at least one application parameter of the foam application device. For example, the foam application device may be controlled to spot spray further foamable material, if indicated also with adjusted application parameters, in order to improve the application quality.

According to an embodiment, processing the received input data may comprise correlating time dependence of foaming, which may be derived, e.g. determined, calculated, modelled, etc., from the formulation information, with the image data, to process the image data using an expected time-dependent foam state and/or determine the application quality based the expected time-dependent foam state. In this way, the application and/or foam quality may be accurately assessed and/or determined during the foaming process, which may take some time. In an embodiment, the application of the foamable material may be performed layer-wise. The method may further comprise: determining the application quality of the applied foamable material layer by layer, and determining, layer by layer, whether or not applying the foamable material is resumed or not. This allows an early decision to be made as to whether the foamable material and/or the application parameter is suitable at all, thus possibly avoiding scrap, saving manufacturing time, etc.

According to an embodiment, the method may further comprise capturing, by the at least one image capturing device, in the image data the surface of the carrier after applying a first application layer of the foamable material, capturing, by the at least one image capturing device, in the image data the surface after applying at least one further application layer applied onto the first application layer, determining, by the computational model, a total score of the plurality of captured layers, and determining the application quality of the applied foamable material based on the determined total score. For example, the total score may be compared to a certain threshold in order to determine the application quality and/or to assess the same. This allows the application quality to be determined in view of the resulting end product where the layers as a whole contribute to the application quality.

In an embodiment, the at least one image capturing device may comprise a thermal imaging camera. The method may further comprise: capturing, by the thermal imaging camera, a series of thermal images, and determining, based on the series of thermal images, the application quality of the applied foamable material by taking into account an exothermic reaction of the foamable material over time. In other words, the foamable material may be monitored during its foaming processes by using a series of images. This allows the application quality to be determined even more precisely.

According to an embodiment, the method may further comprise: determining, based on the captured image data, dimensions of the carrier, and assessing the determined dimensions of the carrier. For example, the dimensions may be deviate from a specification. The assessment may comprise comparing the actual dimensions with the specification.

In an embodiment, the at least one application parameter may comprise one or more of: an ambient temperature measured in an application area where the foamable material is applied, an ambient air humidity measured in an application area where the foamable material is applied, an application pressure of a foam application device, and an application temperature of a foam application device. These parameters may be measured and/or monitored by suitable detection means. Further, the parameters may be adjustable, e.g. based on the above output or control data. This allows the application quality to be determined even more precisely.

A second aspect provides a system for verifying an application of a foamable material onto a carrier. The computing device comprises means configured to carry out the method according to the first aspect. For example, the means may comprise one or more of a data processing unit, a memory, a data interface, a communication interface, etc. In at least some embodiments, the computing device may be configured to:

receive, by at least one data processing unit, captured image data comprising a captured surface of the carrier onto which the foamable material is applied.

receive, by the at least one data processing unit, input data comprising at least the captured image data and at least one application parameter associated therewith.

processing, by the at least one data processing unit, the received input data by performing at least image analysis on the image data and by taking into account the at least one application parameter, and thereby determining an application quality of the applied foamable material. Further, in at least some embodiments, the input data and/or output data may be received and/or provided via at least one data interface. The computing device may be located locally or on-site, i.e. the manufacturing site, at a central site, i.e. the computing cloud, or may form a distributed computer system partly using both computer resources on-site and from the computing cloud.

According to an embodiment, the system may be a computing cloud configured to receive input data from and/or to provide output data to a remote terminal and/or a remote edge computing device. The computing cloud may be operatively connected to a communications network, such as the Internet. It may be operated by e.g. a supplier of the foamable material and/or the foam application device and/or other manufacturing equipment. Further, the remote terminal and/or edge computing device may be operated by a customer that uses it to manufacture the product.

Alternatively, the system may be an edge computing device. Preferably, the edge computing device may be located at a manufacturing site where the foamable material is applied. The edge computing device may be operated independently, and may be temporarily connectable to the computing cloud to, for example, receive data therefrom, such as computation results, updates etc.

A third aspect provides a system for verifying an application of a foamable material onto a carrier at least comprising the computing cloud and the edge computing device. In at least some embodiments, the system may further comprise a terminal, such as a portable device etc.

A fourth aspect provides a method for training a computational model for verifying an application of a foamable material onto a carrier. The method comprises the steps of:

Receiving, preferably initially and/or on a regular basis, input data at least comprising captured image data of a surface of a carrier onto which foamable material is applied, at least one application parameter associated therewith and formulation information of the foamable material.

Computer-readable annotating the received input data and collecting the annotated input data as sample data, the sample data further comprising an assessment of the quality and/or defect of the associated application of the foamable material.

Providing the collected annotated input data to the computational model to learn and/or relearn determining and/or assessing an application quality of the applied foamable material.

The method may be computer-implemented, and may utilize suitable computer means, comprising one or more of a data processing unit, a data interface, a memory, a communication interface, etc. For example, the input data, i.e. the image data and the at least one associated application parameter, may be retrieved from different locations, such as e.g. manufacturing sites and/or costumers, and collected in e.g. a database. On this basis, the computational model may be pre-trained and/or re-trained for determining and/or assessing an application quality of the applied foamable material, preferably under certain application conditions depending on the at least one application parameter associated with a certain locations, manufacturing sites and/or customers. This allows the application quality to be determined even more precisely. In at least some embodiments, the input data may be received, directly or via at least one data interface, by at least one data processing unit. The input data may be generated by an image capturing device, the data of which is processed by a computer device etc. The annotating may be performed by utilizing a computer device running a suitable annotating software or the like. The annotated input data may be provided by the computer means to e.g. a data processing unit that runs the computational model.

The term annotating may be broadly understood as e.g. labelling and/or superimposing visible metadata on an image without changing the underlying image. This may be carried out manually, semi-automatically or fully automatically.

In an embodiment, the input data may be collected from a plurality of manufacturing sites which are at least partly in different geographical locations. As a result, image data may be collected under different environmental conditions, i.e., different temperatures, humidity, etc., and under different application parameters, which may also depend on the environmental conditions. This results in a broad data basis for the sample data.

According to an embodiment, the trained computational model may cause changing one or more application parameters for e.g. a certain location, manufacturing site and/or customer.

In an embodiment, the trained computational model may be provided to a certain location, manufacturing site and/or customer, optionally on a regular basis, for example, whenever it has been re-trained.

A fifth aspect provides computer program element for verifying an application of a foamable material onto a carrier, wherein the computer program element comprises instructions that, when being executed by a computer device, cause the computer device to carry out the method according to the first and/or third aspect.

A sixth aspect computer-readable medium comprising the computer program element of the fifth aspect. The computer-readable medium may be provided as physical data carrier, such as a CD-ROM, a USB stick, or the like, or may be provided digitally via a communications network, such as the Internet. For example, the computer program element may be transmitted by a wireless communications network, such as Bluetooth, Wireless LAN (Wi-Fi), etc.

These and other aspects of the present invention will become apparent from and elucidated with reference to the embodiments described hereinafter.

Exemplary embodiments of the invention will be described in the following with reference to the following drawings.

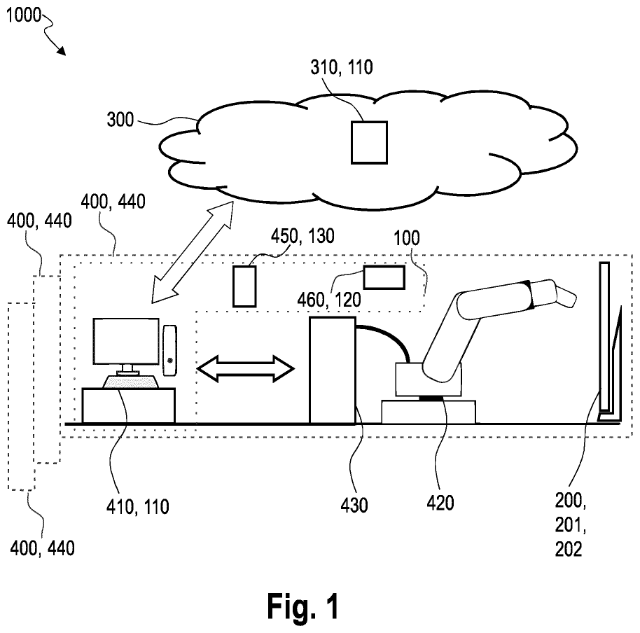

FIG. 1 shows in a schematic block diagram a system for verifying an application of a foamable material onto a carrier as part of a system for applying the foamable material according to an embodiment.

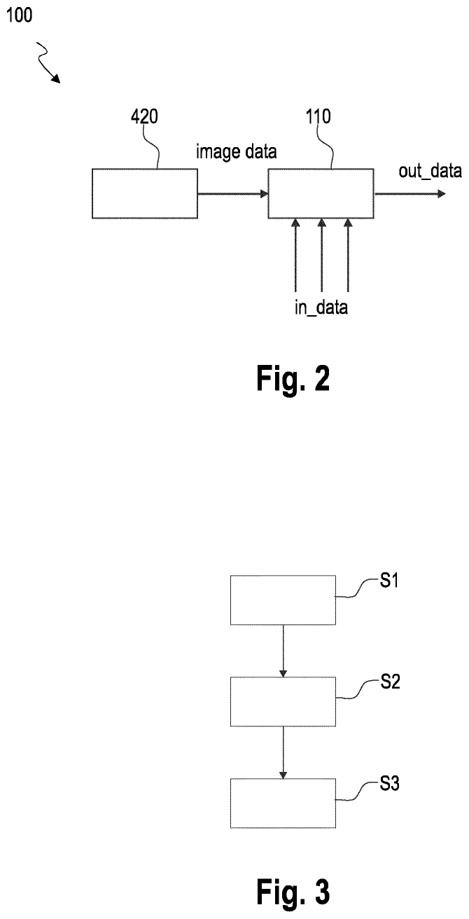

FIG. 2 shows in a schematic block diagram a system for verifying an application of a foamable material onto a carrier according to an embodiment.

FIG. 3 shows in a flow chart a method for for verifying an application of a foamable material onto a carrier according to an embodiment.

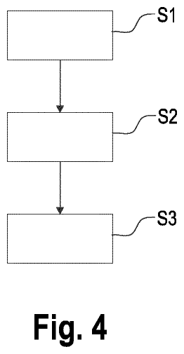

FIG. 4 shows in a flow chart a method for training a computational model for verifying an application of a foamable material onto a carrier according to an embodiment.

The drawings are merely schematic representations and serve only to illustrate the aspects disclosed herein. Identical or equivalent elements are consistently provided with the same reference signs.

FIG. 1 shows in a schematic block diagram a system 100 for verifying an application of a foamable material onto a carrier. By way of example, the system 100 is part of or embedded into a system 1000 for applying the foamable material. In some embodiments, the application of the foamable material may be used to manufacture an insulated member 200 that may be an insulated construction member, such as a construction panel used for panelized buildings, in the prefabricated building industry, or the like. Of course, it may be contemplated that the insulated member 200 is configured different and is adapted to be used in other industries. The insulated member 200 at least comprises a carrier 201, such as a panel, etc., having at least one foamable material application section, e.g. a surface, a cavity or the like, and foamable material 202 applied thereon. In some embodiments, the foamable material 202 may be polyurethane (PUR), or the like. The system 1000 further comprises, at a computing cloud site, a computing cloud 300 which is adapted to provide computer system resources and services via a communications network, such as the Internet. Accordingly, the computing cloud 300 comprises data processing unit 310, which comprises one or more processors, a data storage, a data interface, etc. Further, the system 1000 further comprises, at the manufacturing site (geographically) remote to the computing cloud site, an applicator 400, and in particular a local manufacturing-site edge computer device 410 having a data interface adapted to exchange data with the computing cloud 300, e.g. via a communications network, such as the Internet. Further, at the manufacturing site, system 100, and in particular applicator 400, comprises an application robot 420 adapted to be controlled by the edge computer device 410. In some embodiments, the application robot 420 is an industrial robot having six degrees of freedom. In addition, the application robot 420 is adapted to apply the polymerizing material 202 by spraying, pouring, or the like. For this purpose, the applicator 400, and in particular the application robot 420 comprises, for example, a material outlet that may be provided as a spraying head or the like, a material feeding, a proportioner, a material reservoir 430, material temperature regulating means, material pressure regulating means, etc. Further, at the manufacturing site, system 1000, and in particular applicator 400, comprises a booth 440, which is indicated in FIG. 1 by a dotted line. Within this booth 440 or adjacent thereto, applicator 400 or system 1000, respectively, may have one or more actual climate conditions measuring means 450 at the manufacturing site, and in particular within the booth 440. The actual climate conditions measuring means 450 may be operatively connected to the control computer device 410, and thus to the computing cloud 300.

As indicated in FIG. 1 by dotted lines, there may be a plurality of manufacturing sites each comprising an applicator 400. Likewise, there may be a plurality of applicators 400 located at a certain manufacturing site. Typically, the manufacturing sites may be associated with different geographical locations and/or different environmental and/or climatically conditions. Further, different manufacturing sites may be associated with different users, e.g. costumers. These different manufacturing sites, and/or edge computer devices 410 may optionally connect at least partially and/or temporarily to the computing cloud 300 to communicate, e.g. receive data from there and/or send data to there.

The system 1000 further comprises at least one image capturing device 460 that is arranged to capture one or more images from the carrier 201, e.g. from one or more surfaces, cavities, etc. thereof. It is noted that the image capturing device 460 may also be implemented in a remote terminal, such as portable device, e.g. a mobile phone, a smartphone, or the like. This may also be provided additionally to a fixed device within the booth 440.

The system 100 for verifying an application of the foamable material 202 onto the carrier 201 is indicated by a dotted line. It is noted that the system 100 may be provided separately from the system 1000, so it does not necessarily have to be integrated into it, but may also be added later. Likewise, its components may also be provided separately to system 1000, so that system 100 can have its own components and does not necessarily have to share those of the system 1000. For the sake of better illustration, reference is made below to both the components described for the system 1000 and the components assigned to system 100.

The system 100 for verifying an application of the foamable material 202 onto the carrier 201 comprises at least one data processing unit 110, which may be the data processing unit 310, e.g. a processor, of the computing cloud 300 and/or the edge computer device 410, and at least one image capturing device 120, which may be the at least one image capturing device 460. The system 100 is configured to capture, by the at least one image capturing device 120, 460, in image data a surface of the carrier 201 onto which the foamable material 202 is applied. Further, the system 100 is configured to receive, by at least one data processing unit 110, 310, input data comprising at least the captured image data, at least one application parameter associated therewith and formulation information of the foamable material 202. The application parameter may comprise an ambient temperature measured in an application area where the foamable material 202 is applied, i.e. within the booth 440 using e.g. the actual climate conditions measuring means 450, an ambient air humidity measured in an application area where the foamable material 202 is applied, i.e. within the booth 440 using e.g. the actual climate conditions measuring means 450, an application pressure and an application temperature of the applicator 400. Of course, further application parameter may be measured and provided. Further, the system 100 is configured to process, by the at least one data processing unit 110, 310, 410, the received input data by performing at least image analysis on the image data and by taking into account the formulation information and the at least one application parameter, and thereby determining an application quality of the applied foamable material 202 after applying it onto the carrier 201.

It is noted that system 100 may be operated locally, i.e. by using the edge computer device 410 as the data processing unit 110, or centrally, i.e. by using the computing cloud 300 or its data processing unit 310 as the data processing unit 110. Alternatively, the computational steps may be distributed on both the computing cloud 310 and the edged computer device 410.

FIG. 2 shows the system 100 or verifying an application of the foamable material 202 onto the carrier 201 individually in a schematic block diagram. As can be, seen, the at least one data processing unit 110 is configured, e.g. by comprising one or more data interfaces, to receive the above input data, which are designated here as in_data, and is configured to provide output data, which are designated as out_data.

The system 100 is further configured to generate, by the at least one data processing unit 110, output data at least comprising the determined application quality of the applied foamable material and/or an assessment thereof. These output data may be provided to a user, e.g. costumer, for example, to generate a job report associated with the application job or in form of such a job report. As a result, the user can see whether or not a desired application quality has been met or not.

Further, the system 100 and/or the system 1000 is configured to use the generated output data to adjust, particularly if the determined application quality is considered insufficient, one or more of: the foamable material 202 used, and the at least one application parameter. For example, the system 100 or 1000 respectively may generate suitable control data applied to the applicator 400 to adjust the foamable material 202 and/or one or more of the application parameters, such as an application temperature, application pressure, etc.

It is noted that, in at least some embodiments, the at least one data processing unit 110 utilizes a computational model configured to process the input data and/or determine the application quality, wherein the computational model is trained by sample data at least comprising annotated image data, annotated application parameter data associated therewith and an assessment of the quality or defect of the application of applied foamable material associated therewith.

Further, the system 100 is configured to generate, by the at least one data processing unit 110, control data to be processed by a foam application device, i.e. the applicator 400, wherein the control data is configured to control the foam application device, i.e. the applicator 400, for one or more of: reworking at least one section of the surface of the carrier where the application quality has been determined to be insufficient, and/or adjusting at least one application parameter of the foam application device, i.e. the applicator 400. For example, the application parameter may be adjusted before starting the reworking, or may be adjusted step by step.

As described above, the input data further comprises formulation information of the foamable material. The system 100 is configured to take into account the formulation of the foamable material for determining the application quality of the applied foamable material. The system 100 may optionally be configured to correlate time dependence of foaming, derived from the formulation information, with the image data, to process the image data using an expected time-dependent foam state and/or determine the application quality based the expected time-dependent foam state.

Further, in at least some embodiments, the application of the foamable material is performed layer-wise. The system 100 is configured to determine the application quality of the applied foamable material layer by layer, and to determine, layer by layer, whether or not applying the foamable material is resumed or not. For example, the system 100 may generate a stop signal or the like, if the application quality does not meet a threshold. Further, the system 100 may adjust one or more application parameters before resuming the application process.

The system 100 is further configured to capture, by the at least one image capturing device 120, in the image data the surface of the carrier 201 after applying a first application layer of the foamable material 202. Then, it captures, by the at least one image capturing device 120, in the image data the surface after applying at least one further application layer applied onto the first application layer. Then, the system 100 determines, by the computational model, a total score of the plurality of captured layers, and determines the application quality of the applied foamable material based on the determined total score.

In at least some embodiments, the at least one image capturing device 120 comprises a thermal imaging camera. The system 100 is configured to capture, by the thermal imaging camera, a series of thermal images, and to determine, based on the series of thermal images, the application quality of the applied foamable material by taking into account an exothermic reaction of the foamable material over time.

Further, the system 100 is configured to determine, based on the captured image data, dimensions of the carrier 201, and to assess the determined dimensions of the carrier 201. The result of the assessment may be included in a job report and/or may be trigger other measurements depending on the grade of deviation from specification.

FIG. 3 shows in a flow chart a method for verifying an application of the foamable material 202 onto the carrier 201. The method may be carried out by the above system 100, which may optionally be part of system 1000.

Step S1 comprises capturing, by the at least one image capturing device 120, in image data a surface of the carrier 201 onto which the foamable material 202 is applied.

Step S2 comprises receiving, by the at least one data processing unit 110, input data comprising at least the captured image data, at least one application parameter associated therewith and formulation information of the foamable material.

Step S3 comprises processing, by the at least one data processing unit 110, the received input data by performing at least image analysis on the image data and by taking into account the formulation information and the at least one application parameter, and thereby determining an application quality of the applied foamable material 202.

FIG. 3 shows in a flow chart a method for training the above computational model for verifying an application of the foamable material 202 onto the carrier 201. The training may be performed initially and/or on regular basis in order to retrain or adjust the computational model. The computational model may be carried out locally by using e.g. the edge computer device 410 and/or centrally by using the computing cloud 300 or its data processing unit 310. In some embodiments, the computational model may be carried out by a terminal, such as a portable device.

Step S100 comprises receiving, initially and/or on a regular basis, input data at least comprising captured image data of a surface of the carrier 201 onto which foamable material 202 is applied and at least one application parameter associated therewith.

Step S200, comprises computer-readable annotating the received input data and collecting the annotated input data as sample data, the sample data further comprising an assessment of the quality or defect of the associated application of applied foamable material 202.

Step S3 comprises providing the collected annotated input data to the computational model to learn and/or relearn determining and/or assessing an application quality of the applied foamable material 202.

It is noted that the input data may be collected from a plurality of manufacturing sites which are at least partly in different geographical locations, as indicated in FIG. 1 by reference signs 400, 440 for different manufacturing sites.

It is noted that embodiments of the invention are described with reference to different subject-matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for verifying an application of a foamable material onto a carrier to manufacture an insulated member, the method comprising:
receiving (S1), by at least one data processing unit, image data comprising a captured surface of the carrier onto which the foamable material is applied;
receiving (S2), by the at least one data processing unit, input data comprising at least the captured image data, at least one application parameter associated therewith and formulation information of the foamable material; and
processing (S3), by the at least one data processing unit, the received input data by performing at least image analysis on the image data and by taking into account the at least one application parameter and the formulation information of the foamable material, and thereby determining an application quality of the applied foamable material.

2. The method of claim 1, further comprising:
generating, by the data processing unit, output data at least comprising the determined application quality of the applied foamable material and/or an assessment thereof.

3. The method of claim 2, wherein the output data is used to adjust one or more of: the foamable material used, and the at least one application parameter.

4. The method of claim 1,
wherein the at least one data processing unit utilizes a computational model configured to process the input data and/or determine the application quality, and
wherein the computational model is trained by sample data at least comprising annotated image data, annotated application parameter data associated therewith and an assessment of the quality or defect of the application of applied foamable material associated therewith.

5. The method of claim 1, further comprising:
generating, by the at least one data processing unit, control data to be processed by a foam application device,
wherein the control data is configured to control the foam application device for one or more of: reworking at least one section of the surface of the carrier where the application quality has been determined to be insufficient, and/or adjusting at least one application parameter of the foam application device.

6. The method of claim 1, wherein processing the received input data comprises correlating time dependence of foaming, derived from the formulation information, with the image data, to process the image data using an expected time-dependent foam state and/or determine the application quality based the expected time-dependent foam state.

7. The method of claim 1, wherein the application of the foamable material is performed layer-wise, and the method further comprises:
determining the application quality of the applied foamable material layer by layer, and
determining, layer by layer, whether or not applying the foamable material is resumed or not.

8. The method of claim 1, further comprising:
capturing, by the at least one image capturing device, in the image data the surface of the carrier after applying a first application layer of the foamable material,
capturing, by the at least one image capturing device, in the image data the surface after applying at least one further application layer applied onto the first application layer,
determining, by the computational model, a total score of the plurality of captured layers, and
determining the application quality of the applied foamable material based on the determined total score.

9. The method of claim 1, wherein the at least one image capturing device comprises a thermal imaging camera, and the method further comprises:
capturing, by the thermal imaging camera, a series of thermal images, and
determining, based on the series of thermal images, the application quality of the applied foamable material by taking into account an exothermic reaction of the foamable material over time.

10. The method of claim 1, further comprising:
determining, based on the captured image data, dimensions of the carrier, and
assessing the determined dimensions of the carrier.

11. The method of claim 1, wherein the at least one application parameter comprises one or more of: an ambient temperature measured in an application area where the foamable material is applied, an ambient air humidity measured in an application area where the foamable material is applied, an application pressure of a foam application device, and an application temperature of a foam application device.

12. A system for verifying an application of a foamable material onto a carrier to manufacture an insulated member, comprising:
means configured to carry out the method according to claim 1.

13. The system of claim 12, further comprising a computing cloud configured to receive input data from and/or to provide output data to a remote terminal.

14. A method for training a computational model for verifying an application of a foamable material onto a carrier to manufacture an insulated member, the method comprising:
receiving (S1), initially and/or on a regular basis, input data at least comprising captured image data of a surface of a carrier onto which foamable material is applied, at least one application parameter associated therewith, and formulation information of the foamable material,
computer-readable annotating (S2) the received input data and collecting the annotated input data as sample data, the sample data further comprising an assessment of the quality or defect of the associated application of applied foamable material, and
providing (S3) the collected annotated input data to the computational model to learn and/or relearn determining and/or assessing an application quality of the applied foamable material.

15. The method of claim 14, wherein the input data is collected from a plurality of manufacturing sites which are at least partly in different geographical locations.

16. The method of claim 2, wherein the output data is used to adjust, if the determined application quality is considered insufficient, one or more of: the foamable material used, and the at least one application parameter.
